(19) United States
(12) Patent Application Publication
(10) Pub. No.: US 2019/0392291 A1
(43) Pub. Date: Dec. 26, 2019

(54) ELECTRONIC CIRCUIT FOR IMPLEMENTING GENERATIVE ADVERSARIAL NETWORK USING SPIKE NEURAL NETWORK

(71) Applicant: Electronics and Telecommunications Research Institute, Daejeon (KR)

(72) Inventors: Seong Mo PARK, Daejeon (KR); Jae-Jin LEE, Daejeon (KR); Sung Eun KIM, Daejeon (KR); Kyung Hwan PARK, Daejeon (KR); Mi Jeong PARK, Sejong-si (KR); Young Hwan BAE, Daejeon (KR); Kwang IL OH, Daejeon (KR); Byounggun CHOI, Daejeon (KR)

(73) Assignee: Electronics and Telecommunications Research Institute, Daejeon (KR)

(21) Appl. No.: 16/445,925

(22) Filed: Jun. 19, 2019

(30) Foreign Application Priority Data
Jun. 19, 2018 (KR) 10-2018-0070466

(51) Int. Cl. G06N 3/04

(52) U.S. Cl. CPC G06N 3/049; G06N 3/0481

(57) ABSTRACT

Provided is an electronic circuit for implementing a generative adversarial neural network. The electronic circuit includes a spike converter, a spike image generator, a spike image converter, and an image discriminator. The spike converter generates a first signal including spike signals. The number of the spike signals is determined based on first data associated with second data within a reference time interval. The spike image generator generates a second signal including spike signals being selected based on a weight among the spike signals of the first signal. The image converter converts the spike signals of the second signal to generate third data being represented in an analog domain. The image discriminator provides the spike image generator with result data being associated with a difference between a value of the third data and a value of the second data. The image generator determines the weight based on the result data.

### CROSS-REFERENCE TO RELATED APPLICATIONS

This U.S. non-provisional patent application claims priority under 35 U.S.C. § 119 of Korean Patent Application No. 10-2018-0070466, filed on Jun. 19, 2018, the entire contents of which are hereby incorporated by reference.

### BACKGROUND

Embodiments of the inventive concept relate to an electronic circuit, and more particularly, to an electronic circuit for implementing a generative adversarial neural network.

Neural network refers to algorithms for modeling human brains, and electronic devices for implementing the algorithms. The neural network contains numerous neurons as a basic unit, and neurons transmit signals to other neurons through synapses.

The neural network is used to perform machine learning. The neural network may perform learning based on input training data. For example, the neural network may learn characteristics and patterns of input training data. The neural network may generate solutions to newly entered problems, based on performed learning.

Machine learning may be classified into supervised learning and unsupervised learning. A designer may provide training data, which include an input value and a target value for the input value, to allow the neural network to perform the supervised learning. On the other hand, a designer may provide training data, which do not include the target value, to allow the neural network to perform the unsupervised learning.

### SUMMARY

Embodiments of the inventive concept provide an electronic circuit for implementing a generative adversarial neural network, which generates data having values similar to those of data input by a designer, through a neural network operating based on a spike signal.

According to an exemplary embodiment, an electronic circuit for implementing a generative adversarial neural network may include a spike converter, a spike image generator, an image converter, and an image discriminator. The spike converter may generate a first signal including spike signals. The number of the spike signals is determined based on first data associated with second data within a reference time interval. The spike image generator may generate a second signal including spike signals being selected based on a weight among the spike signals of the first signal. The image converter may convert the spike signals of the second signal to generate third data being represented in an analog domain. The image discriminator may provide the spike image generator with result data being associated with a difference between a value of the third data and a value of the second data. The image generator may determine the weight based on the result data.

### BRIEF DESCRIPTION OF THE FIGURES

FIG. 1 is a block diagram illustrating an electronic circuit for implementing a generative adversarial neural network according to an embodiment of the inventive concept.

FIG. 2 is a graph for describing exemplary pixel values of seed data and real data of FIG. 1.

FIGS. 3 and 4 are graphs for describing signals converted from pixel values of seed data.

FIG. 5 is a block diagram illustrating an exemplary model of a spike image generator of FIG. 1.

FIG. 6 is a block diagram illustrating an exemplary configuration of a spike image generator of FIG. 1.

FIG. 7 is a block diagram illustrating a detail configuration of a post-synaptic neuron of FIG. 6.

FIG. 8 is a graph for describing spike signals received in a synapse circuit of FIG. 6.

FIG. 9 is a graph for describing an exemplary level of voltage accumulated by an accumulation circuit of FIG. 7.

FIG. 10 is a graph for describing exemplary signals generated by a spike image generator of FIG. 1.

FIG. 11 is a graph for describing real data and fake data received by an image discriminator of FIG. 1.

### DETAILED DESCRIPTION

Embodiments of the inventive concept will be described below in more detail with reference to the accompanying drawings. In the following descriptions, details such as detailed configurations and structures are provided merely to assist in an overall understanding of embodiments of the inventive concept. Modifications of the embodiments described herein can be made by those skilled in the art without departing from the spirit and scope of the inventive concept. Furthermore, descriptions of well-known functions and structures are omitted for clarity and brevity. The terms used in this specification are defined in consideration of the functions of the inventive concept and are not limited to specific functions. Definitions of terms may be determined based on the description in the detailed description.

In the following drawings or the detailed description, modules may be connected to others in addition to the components illustrated in drawing or described in the detailed description. The modules or components may be directly or indirectly connected. The modules or components may be communicatively connected or may be physically connected.

Unless defined otherwise, all terms including technical and scientific terms used herein have the same meaning as can be understood by one of ordinary skill in the art to which the inventive concept belongs. Generally, terms defined in the dictionary are interpreted to have equivalent meaning to the contextual meanings in the related art and are not to be construed as having ideal or overly formal meaning unless expressly defined in the text. The term “spike signal” used herein means a pulse-shaped signal having a magnitude that changes abruptly for a relatively short time. The term “firing” used herein means outputting spike signal(s), especially by neurons (or neuron circuit, neuromorphic circuit).

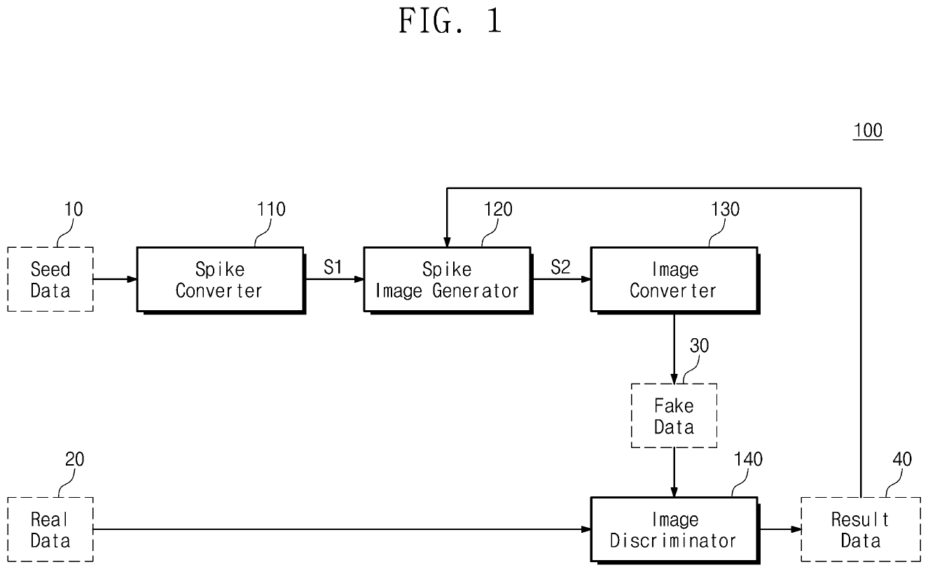

FIG. 1 is a block diagram illustrating an electronic circuit for implementing a generative adversarial neural network according to an embodiment of the inventive concept.

Referring to FIG. 1, an electronic circuit 100 may include a spike converter 110, a spike image generator 120, an image converter 130, and an image discriminator 140. The spike converter 110 may receive seed data 10. For example, a designer of the electronic circuit 100 may provide the seed data 10 associated with real data 20 to the spike converter 110.

By way of example, the seed data 10 and the real data 20 may be data associated with an image. Although an embodiment of the seed data 10 and the real data 20 for representing brightness of the image will be described herein, it will be appreciated that the inventive concept may include embodiments of the seed data 10 and the real data 20 to represent various information such as various characteristics associated with the image, voice, and text.

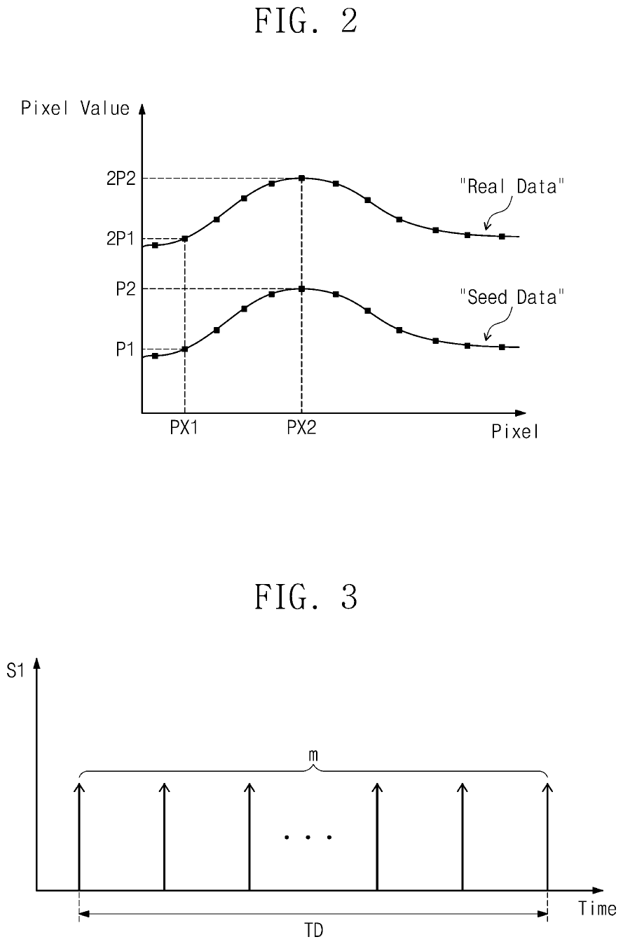

As an example, the real data 20 may represent values (hereinafter, “pixel values”) corresponding to the brightness of pixels that represent real images (e.g., photographs and images captured by a camera or the like). The designer may provide the seed data 10 having values that are calculated based on the pixel values of the real data 20 to the spike converter 110. As an example, the seed data 10 may have intermediate values of pixel values of the real data 20 as the pixel values. An exemplary relationship between the seed data 10 and the real data 20 will be described in more detail with reference to FIG. 2.

The spike converter 110 may receive the seed data 10 from the designer. The spike converter 110 may generate a signal S1 based on the seed data 10 that is received. As an example, the spike converter 110 may convert the pixel values of the seed data 10 into spike signals based on a Poisson Distribution. The spike converter 110 may output the signal S1 including the converted spike signals to the spike image generator 120.

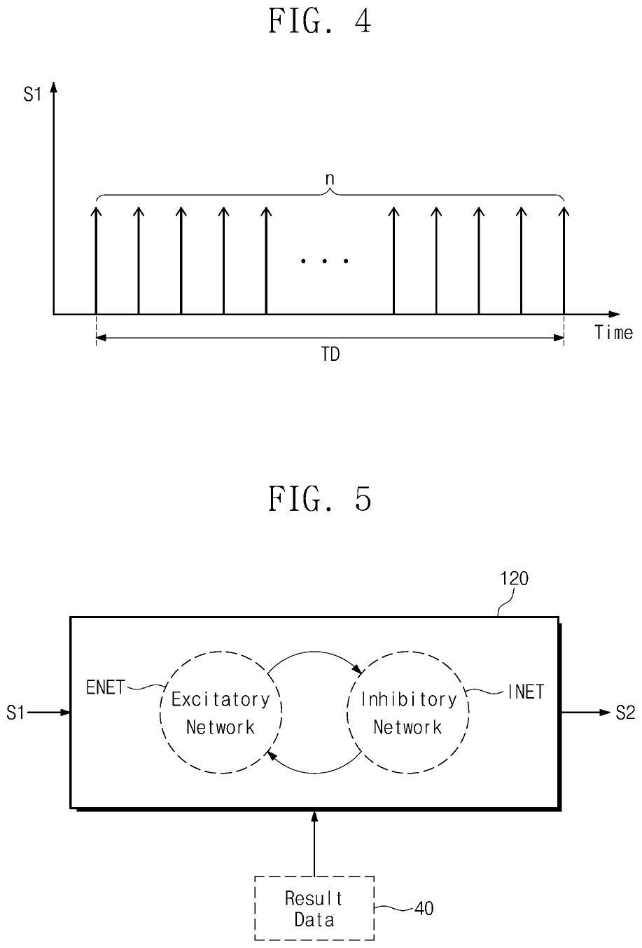

The signal S1 may have a frequency value. In following description, the frequency value refers to the number of the spike signals that are included in a time interval of a unit time interval. For example, when a certain signal includes “n” spike signals in the time interval of the unit time interval, the frequency value of the certain signal may be “n” in a time domain. For example, as the pixel value of the seed data 10 increases, the frequency value of the signal S1 may increase. The frequency values of the signal S1, which are determined based on the pixel value of the seed data 10, will be described in more detail with reference to FIGS. 3 and 4,

The spike image generator 120 may receive the signal S1 from the spike converter 110. The spike image generator 120 may receive result data 40 that are generated by the image discriminator 140. The spike image generator 120 may generate a signal S2 from the signal S1, based on the result data 40. The spike image generator 120 may output the signal S2 to the image converter 130.

The spike image generator 120 may include electronic circuits that have a form of the neural network for generating the signal S2. The spike image generator 120 may be implemented as the neural network which has characteristics (i.e., plasticity) that vary depending on the result data 40. The spike image generator 120 may generate the signal S2 that includes spike signals selected among the spike signals included in the signal S1, through learning based on a Spike-Timing-Dependent Plasticity (STDP).

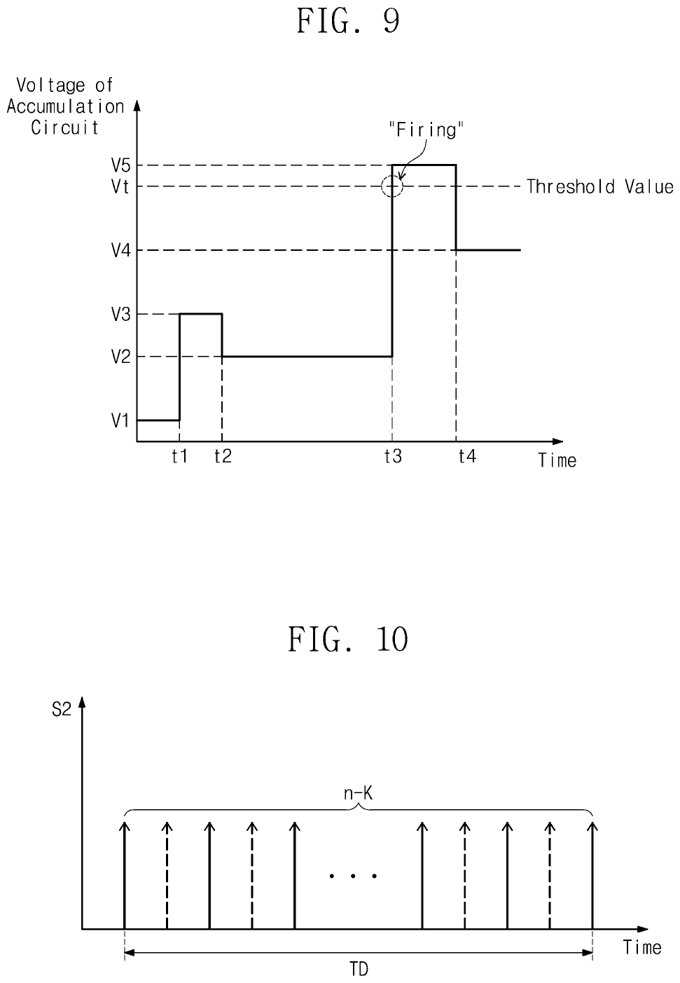

By way of example, the spike image generator 120 may generate the signal S2 including the spike signals from the signal S1, by the neural network that is learned based on the result data 40. Exemplary configurations and operations of the spike image generator 120 will be described in more detail with reference to FIGS. 5 to 8. Exemplary spike signals included in the signal S2 will be described in more detail with reference to FIG. 9.

The image converter 130 may receive the signal S2 from the spike image generator 120. The image converter 130 may generate fake data 30, based on the signal S2. In more detail, the image converter 130 may generate the fake data 30 having analog values that are generated by converting the spike signals included in the signal S2.

The conversion that is performed by the image converter 130 may be inverse conversion with respect to a conversion that is performed by the spike converter 110. For example, the image converter 130 may convert the spike signals that are included in the signal S2 into the fake data 30, based on the Poisson Distribution. By way of example, the fake data 30 may have a pixel value that represents the brightness of an image. The image converter 130 may output the fake data 30 to the image discriminator 140.

The image discriminator 140 may receive the fake data 30 from the image converter 130. The image discriminator 140 may receive the real data 20. For example, the image discriminator 140 may receive the real data 20 that are provided by the designer of the electronic circuit 100. The image discriminator 140 may generate various information, based on the real data 20 and the fake data 30. As an example, the image discriminator 140 may generate the result data 40 that is associated with a difference between the pixel value of the real data 20 and the pixel value of the fake data 30.

The image discriminator 140 may output the result data 40 to the spike image generator 120 to feed back the result data 40. Since the spike image generator 120 generates the signal S2 through the neural network learned based on the result data 40 that is fed back, the pixel value of the fake data 30 generated based on the signal S2 may vary based on the result data 40.

For better understanding, an example of the result data 40 having a value that is obtained by deducting the pixel value of the fake data 30 from the pixel value of the real data 20 will be described. However, it will be appreciated that the inventive concept encompasses embodiments of the result data 40 that represent various information for learning of the neural network included in the spike image generator 120. Examples of the real data 20 and the fake data 30 received in the image discriminator 140 will be described in more detail with reference to FIG. 10.

As described above with reference to FIG. 1, the seed data 10 are converted into the spike signals, and the converted spike signals may be processed, by operations of the spike converter 110, the spike image generator 120, and the image converter 130. When certain data are converted into discrete signals at the time of processing data, rather than being processed in the analog domain, the time and power for processing the certain data may decrease. Therefore, the electronic circuit 100 may generate the fake data 30 from the seed data 10 by consuming relatively reduced time and power.

FIG. 2 is a graph for describing exemplary pixel values of seed data and real data of FIG. 1.

In the example of FIG. 2, an x-axis represents pixels that indicate a certain image, and a y-axis represents pixel values of the seed data 10 and the real data 20. Referring to FIG. 2, the pixel values of the real data 20 may be twice the pixel values of the seed data 10. In detail, the designer may input the seed data 10 that have intermediate values of the pixel values of the real data 20 as the pixel values to the spike converter 110.

As an example, a pixel value of the seed data 10 corresponding to a pixel “PX1” may be “P1” and the pixel value of the real data 20 may be “2P1”. A pixel value of the seed data 10 corresponding to a pixel “PX2” may be “P2” and a pixel value of the real data 20 may be “2P2”. By way of example, a certain image may be represented by a plurality of pixels that include the pixel “PX1” and the pixel “PX2”. The pixel values of a plurality of pixels, which represent the seed data 10 and the real data 20, may be sequentially input to the spike converter 110 and the image discriminator 140, respectively.

FIGS. 3 and 4 are graphs for describing signals converted from pixel values of seed data.

In the example of FIGS. 3 and 4, x-axes may represent a time and y-axes may represent a magnitude of the signal S1. As described with reference to FIG. 1, the spike converter 110 may generate the signal S1 that is converted from the seed data 10. Referring to FIG. 3, the signal S1, which is converted from the pixel value “P1” of the pixel “PX1” of FIG. 2, will be described, and referring to FIG. 4, the signal S1, which is converted from the pixel value “P2” of the pixel “PX2” of FIG. 2, will be described.

The pixel value “P1” of the pixel “PX1” and the pixel value “P2” of the pixel “PX2” may be sequentially input to the spike converter 110, as described with reference to FIG. 1. As an example, after the pixel value “P1” of the pixel “PX1” is input to the spike converter 110, the pixel value “P2” of the pixel “PX2” may be input to the spike converter 110.

The signal S1 may have a certain frequency value. In the example of FIG. 3, the signal S1 may include “m” spike signals in a time interval having a time interval “TD”. In the example of FIG. 4, the signal S1 may include “n” spike signals in a time interval having a time interval “TD”. The “n” may be greater than the “m”. Thus, the signal S1 that corresponds to the pixel value “P2” of the pixel “PX2” during the time interval TD may include a greater number of spike signals than the signal S1 that corresponds to the pixel value “P1” of the pixel “PX1”.

The pixel value may be associated with the frequency value of the signal S1 that is converted from the pixel value. For example, as the pixel value increases, the frequency value of the signal S1 may increase. Referring to FIG. 2 together with FIGS. 3 and 4, the pixel value “P2” may be greater than the pixel value “P1”. Therefore, the frequency value of the signal S1 that corresponds to the pixel value “P2” may be greater than the frequency value of the signal S1 that corresponds to the pixel value “P1”.

FIG. 5 is a block diagram illustrating an exemplary model of a spike image generator of FIG. 1.

As described with reference to FIG. 1, the spike image generator 120 may be implemented through a neural network that is configured to perform the STDP-based learning. The neural network may be comprised of a plurality of neurons configured to operate in response to the spike signal and synapses configured to transmit signals among the neurons.

Referring to FIG. 5, the neural network of the spike image generator 120 may be modeled as including an excitatory network (ENET) and an inhibitory network (INET). In more detail, the neural network for implementing the spike image generator 120 may include configurations of the excitatory network (ENET) and the inhibitory network (INET) that change characteristics of synapses between the neurons.

The excitatory network (ENET) may be associated with configurations for reinforcing the synapse between the neurons that are included in the neural network, based on the result data 40 that are received from the image discriminator 140. The inhibitory network (INET) may be associated with configurations for inhibiting the synapse between the neurons that are included in the neural network, based on the result data 40 that are received from the image discriminator 140.

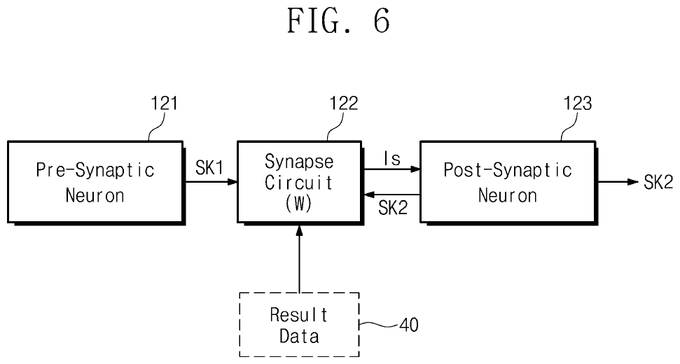

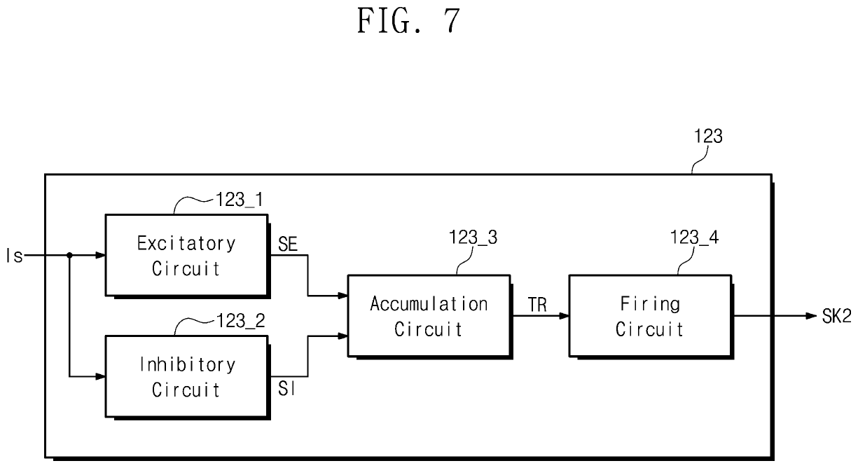

As used herein, an “excitatory” of the synapse refers to changing the characteristics of the synapse such that the magnitude of the signal transmitted by the synapse increases. An “inhibitory” of the synapse refers to changing the characteristics of the synapse such that the magnitude of the signal transmitted by the synapse decreases. Exemplary configurations and operations of the spike image generator 120, which is modeled as the excitatory network (ENET) and the inhibitory network (INET), will be described in more detail with reference to FIGS. 6 to 8.

FIG. 6 is a block diagram illustrating an exemplary configuration of a spike image generator of FIG. 1.

Referring to FIG. 6, the spike image generator 120 may include a pre-synaptic neuron 121, a synapse circuit 122, and a post-synaptic neuron 123. For a better explanation, although exemplary operations of the pre-synaptic neuron 121, the synapse circuit 122, and the post-synaptic neuron 123 will be described, it will be appreciated that the spike image generator 120 may include a number of pre-synaptic neurons, a number of post-synaptic neurons, and synapse circuits that are configured to transmit signals between the pre-synaptic neurons and the post-synaptic neurons. The pre-synaptic neurons, the post-synaptic neurons, and the synapse circuits are configured to perform operations similar to those of the pre-synaptic neuron 121, the synapse circuit 122, and the post-synaptic neuron 123, respectively.

A front stage of the pre-synaptic neuron 121 may be connected to another synapse circuit. The pre-synaptic neuron 121 may operate as the post-synaptic neuron for another synapse circuit that is provided at a previous stage of the pre-synaptic neuron 121. Further, another synapse circuit may be connected to a post end of the post-synaptic neuron 123. The post-synaptic neuron 123 may operate as the pre-synaptic neuron for another synapse circuit that is disposed at a post stage of the post-synaptic neuron 123.

The pre-synaptic neuron 121 may generate a spike signal SK1, based on the spike signal that is transmitted from the synapse circuit(s) of the previous stage of the pre-synaptic neuron 121. Alternatively, the pre-synaptic neuron 121 may generate the spike signal SK1, based on the spike signal of the signal S1 that is received from the spike converter 110 of FIG. 1. The method for generating the spike signal SK1 by the pre-synaptic neuron 121 is similar to the method for generating a spike signal SK2 by the post-synaptic neuron 123, and thus, a description thereof will be omitted.

The pre-synaptic neuron 121 may output the spike signal SK1 to the synapse circuit 122. The post-synaptic neuron 123 may receive the signal Is from the synapse circuit 122. The post-synaptic neuron 123 may generate the spike signal SK2, based on the received signal Is. The post-synaptic neuron 123 may output the spike signal SK2 to the synapse circuit 122 and another synapse circuit that is connected to the post stage of the post-synaptic neuron 123. The post-synaptic neuron 123 may output the spike signal SK2 as the signal S2 (in FIG. 1) to the image converter 130 of FIG. 1.

The synapse circuit 122 may receive the spike signal SK1 from the pre-synaptic neuron 121 and the spike signal SK2 from the post-synaptic neuron 123. The synapse circuit 122 may receive the result data 40 from the image discriminator 140. The synapse circuit 122 may generate the signal Is having a level and a magnitude that are determined based on a time at which the spike signal SK1 is received and a time at which the spike signal SK2 is received. The synapse circuit 122 may also generate the signal Is having a magnitude in accordance with a weight W that is determined based on the result data 40. The synapse circuit 122 may output the signal Is to the post-synaptic neuron 123.

The synapse circuit 122 may generate the signal Is having the level that is determined based on the times at which the spike signal SK1 and the spike signal SK2 are received. For example, when the spike signal SK1 is received earlier than the spike signal SK2, the synapse circuit 122 may generate the signal Is having a positive level by a Long Term Potentiation (LTP). When the spike signal SK2 is received earlier than the spike signal SK1, the synapse circuit 122 may generate the signal Is having a negative level by a Long Term Depression (LTD). However, it will be appreciated that the manner in which the level of the signal “Is” is determined based on the spike signal SK1 and the spike signal SK2 may be variously modified and changed without departing from the inventive concept.

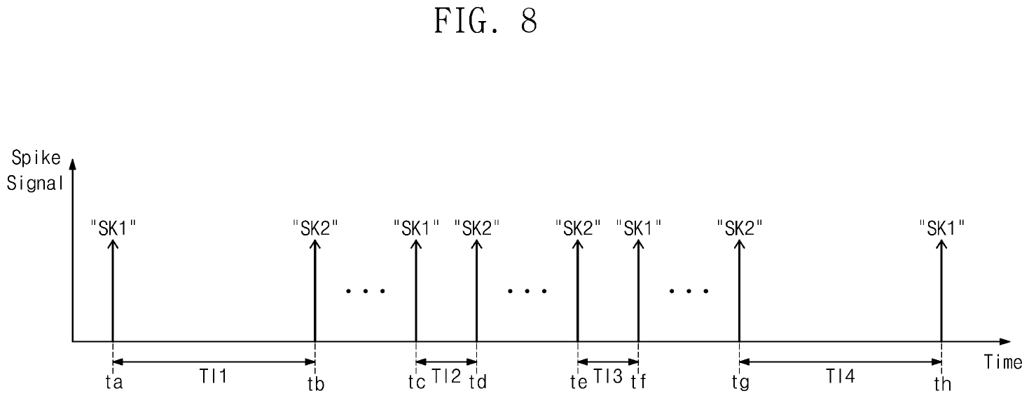

The synapse circuit 122 may generate the signal Is having the magnitude that is determined based on a difference between the times at which the spike signal SK1 and the spike signal SK2 are received. For example, as the difference between the time at which the spike signal SK1 is received and the time at which the spike signal SK2 is received increases, the magnitude of the signal Is may increase. However, it will be appreciated that the manner in which the magnitude of the signal “Is” is determined based on the spike signal SK1 and the spike signal SK2 may be variously modified and changed without departing from the inventive concept. Examples of a signal SE and a signal SI output based on the spike signal SK1 and the spike signal SK2 will be described in more detail with reference to FIG. 8.

The synapse circuit 122 may have the weight W that is determined based on the result data 40. As described with reference to FIG. 1, the result data 40 may have a difference value between the pixel value of the real data 20 and the pixel value of the fake data 30. For example, the result data 40 may have the value that is obtained by deducting the pixel value of the fake data 30 from the pixel value of the real data 20. When the result data 40 has the positive value, the weight W of the synapse circuit 122 may increase. When the result data 40 has the negative value, the weight W of the synapse circuit 122 may decrease. However, it will be appreciated that the manner in which the weight W is determined based on the result data 40 may be variously modified and changed without departing from the inventive concept.

The synapse circuit 122 may generate the signal Is having the magnitude that is determined based on the weight W. For example, with regard to certain spike signals (SK1 and SK2), when the difference between the time at which the spike signal SK1 is received and the time at which the spike signal SK2 is received is fixed, as the weight W increases, the magnitude of the signal Is may increase. However, it will be appreciated that the manner in which the magnitude of the signal “Is” is determined based on the result data 40 may be variously modified and changed without departing from the inventive concept.

As described with reference to FIG. 5, the spike image generator 120 may be modeled as the excitatory network (ENET) and the inhibitory network (INET). An operation of exciting or inhibiting the synapses that are included in the spike image generator 120, by the excitatory network (ENET) and the inhibitory network (INET), may correspond to the operation in which the weight W of the synapse circuit 122 is adjusted based on the result data 40 that is fed back. By way of example, the operation in which the synapse is excited by the excitatory network (ENET) may correspond to the operation in which the weight W of the synapse circuit 122 increases based on the result data 40. The operation in which the synapse is depressed by the inhibitory network (INET) may correspond to the operation in which the weight W of the synapse circuit 122 decreases based on the result data 40.

The post-synaptic neuron 123 may accumulate a level of the signal Is that is received from the synapse circuit 122. The post-synaptic neuron 123 may generate and output the spike signal SK2 when the level of the accumulated signal Is exceeds (is greater than) a threshold value (e.g., Vt in FIG. 9).

FIG. 7 is a block diagram illustrating a detail configuration of a post-synaptic neuron of FIG. 6.

Referring to FIG. 7, the post-synaptic neuron 123 may include an excitatory circuit 123_1, an inhibitory circuit 123_2, an accumulation circuit 123_3, and a firing circuit 123_4. The excitatory circuit 123_1 and the inhibitory circuit 123_2 may receive the signal Is from the synapse circuit 122 of FIG. 6.

Depending on the level of the signal Is, one of the excitatory circuit 123_1 and the inhibitory circuit 123_2 may operate. When the signal Is has a positive level, the excitatory circuit 123_1 may generate a signal SE having a positive level that corresponds to the level of the signal Is. When the signal Is has a negative level, the inhibitory circuit 123_2 may generate a signal SI having the negative level that corresponds to the level of the signal Is. By way of example, the level of the signal Is and the level of the signal SE may be substantially equal to each other, or the level of the signal Is and the level of the signal SI may be substantially equal to each other. When the level of the signal “Is” is “0”, the excitatory circuit 123_1 and the inhibitory circuit 123_2 may not operate.

The excitatory circuit 123_1 may output the signal SE to the accumulation circuit 123_3. The inhibitory circuit 123_2 may output the signal SI to the accumulation circuit 123_3. The level of signal Is may be determined based on the times at which the spike signal SK1 and the spike signal SK2 are received into the synapse circuit 122. Thus, whether the signal SE and the signal SI are output may be associated with the times at which the spike signal SK1 and the spike signal SK2 are received into the synapse circuit 122. The magnitude of the signal SE and the signal SI may also be associated with the times at which the spike signal SK1 and the spike signal SK2 are received into the synapse circuit 122.

The magnitudes of the signal SE and the signal SI may correspond to the magnitude of the signal Is. For example, as the magnitude of the signal Is increases, the magnitude of the signal SE and the magnitude of the signal SI may increase. Since the magnitude of the signal “Is” is determined based on the result data 40 that are received from the image discriminator 140 and the weight W of the synapse circuit 122 that depends on the result data 40, the magnitudes of the signal SE and the signal SI may be associated with the result data 40 and the weight W of the synapse circuit 122.

The accumulation circuit 123_3 may accumulate the levels of the signal SE and the signal SI that are received from the excitatory circuit 123_1 and the inhibitory circuit 123_2, respectively. Since the signal SE has the positive level, the accumulation circuit 123_3 may accumulate the magnitude of the signal SE as the positive value. Since the signal SI has the negative level, the accumulation circuit 123_3 may accumulate the magnitude of the signal SI as the negative value.

As an example, the accumulation circuit 123_3 may accumulate a level of a voltage, based on the signal SE and the signal SI. An exemplary level of the voltage, which is accumulated in the accumulation circuit 123_3, will be described in more detail with reference to FIG. 9. When the level of the accumulated voltage exceeds (is greater than) a threshold value (e.g., Vt in FIG. 9), the accumulation circuit 123_3 may generate the signal TR. The accumulation circuit 123_3 may output a signal TR to the firing circuit 123_4.

The firing circuit 123_4 may receive the signal TR from the accumulation circuit 123_3. The firing circuit 123_4 may generate the spike signal SK2 in response to the signal TR. The firing circuit 123_4 may output the spike signal SK2 to the synapse circuit 122 and other synapse circuits that are located at the post stage of the post-synaptic neuron 123, in FIG. 6. The firing circuit 123_4 may output the spike signal SK2 as the signal S2 in FIG. 1.

Although the embodiment in which the levels of the accumulation circuit 123_3 are accumulated based on the signals SE and SI that are output from the excitatory circuit 123_1 and the inhibitory circuit 123_2, is described with reference to FIG. 7, it will be appreciated that the inventive concept may be implemented in various configurations for accumulating the signal Is that is generated based on the spike signals SK1 and SK2 and the weight W, in the accumulation circuit 123_3.

FIG. 8 is a graph for describing exemplary spike signals received in a synapse circuit of FIG. 6. In the example of FIG. 8, an x-axis represents a time and a y-axis represents the magnitude of the spike signals SK1 and SK2 that are received into the synapse circuit 122.

At a time “ta”, the synapse circuit 122 may receive the spike signal SK1 from the pre-synaptic neuron 121. At a time “tb” after a time interval “TI1” from the time “ta”, the synapse circuit 122 may receive the spike signal SK2 from the post-synaptic neuron 123. Since the synapse circuit 122 receives the spike signal SK1 before the spike signal SK2, the synapse circuit 122 may output the signal Is having the positive level by the LTP.

At a time “tc”, at which arrives after the time tb, the synapse circuit 122 may receive the spike signal SK1 from the pre-synaptic neuron 121. At a time “td” after a time interval “TI2” from the time “tc”, the synapse circuit 122 may receive the spike signal SK2 from the post-synaptic neuron 123. Since the synapse circuit 122 receives the spike signal SK1 before the spike signal SK2, the synapse circuit 122 may output the signal Is having the positive level by the LTP.

At a time “te” at which arrives after the time “td”, the synapse circuit 122 may receive the spike signal SK2 from the post-synaptic neuron 123. At a time “tf” after time interval “TI3” from the time “te”, the synapse circuit 122 may receive the spike signal SK1 from the pre-synaptic neuron 121. Since the synapse circuit 122 receives the spike signal SK2 before the spike signal SK1, the synapse circuit 122 may output the signal Is having the negative level by the LTD.

At a time “tg” at which arrives after the time “tf”, the synapse circuit 122 may receive the spike signal SK2 from the post-synaptic neuron 123. At a time “th” after a time interval “TI4” from the time “tg”, the synapse circuit 122 may receive the spike signal SK1 from the pre-synaptic neuron 121. Since the synapse circuit 122 receives the spike signal SK2 before the spike signal SK1, the synapse circuit 122 may output the signal Is having the negative level by the LTD.

In the example of FIG. 8, the time interval TI1 may be longer than the time interval TI2, and the time interval TI4 may be longer than the time interval TI3. As described with reference to FIG. 6, the time intervals TI1, TI2, TI3, and TI4 may be associated with the magnitude of the signal Is.

As an example, the magnitude of the signal Is, which is output based on the spike signal SK1 received at the time “ta” and the spike signal SK2 received at the time “tb”, may be greater than the magnitude of the signal Is, which is output based on the spike signal SK1 received at the time “tc” and the spike signal SK2 received at the time “td”. As an example, the magnitude of the signal Is, which is output based on the spike signal SK2 received at the time “tg” and the spike signal SK1 received at the time “th”, may be greater than the magnitude of the signal Is, which is output based on the spike signal SK2 received at the time “te” and the spike signal SK1 received at the time “tf”.

FIG. 9 is a graph for describing an exemplary level of voltage accumulated by an accumulation circuit of FIG. 7. In the example of FIG. 9, an x-axis represents a time and a y-axis represents a level of a voltage that is accumulated in the accumulation circuit 123_3.

Before a time “t1”, a level of a voltage, which is accumulated in the accumulation circuit 123_3, may be “V1”. At the time “t1”, the accumulation circuit 123_3 may accumulate the signal SE that is received from the excitatory circuit 123_1. At the time “t1”, the level of the voltage, which is accumulated in the accumulation circuit 123_3, may increase from “V1” to “V3”.

Between the time “t1” and a time “t2”, the level of the voltage, which is accumulated in the accumulation circuit 123_3, may be “V3”. At the time “t2”, the accumulation circuit 123_3 may accumulate the signal SI that is received from the inhibitory circuit 123_2. At the time “t2”, the level of the voltage, which is accumulated in the accumulation circuit 123_3, may decrease from “V3” to “V2”.

Between the time “t2” and a time “t3”, the level of the voltage, which is accumulated in the accumulation circuit 123_3, may be “V2”. At the time “t3”, the accumulation circuit 123_3 may accumulate the signal SE that is received from the excitatory circuit 123_1. At the time “t3”, the level of the voltage, which is accumulated in the accumulation circuit 123_3, may increase from “V2” to “V5”.

A threshold value “Vt” may be greater than “V2” and less than “V5”. Thus, at the time “t3”, the magnitude of the voltage of the accumulation circuit 123_3 may exceed (be greater than) the threshold value “Vt”. The accumulation circuit 123_3 in FIG. 7 may output the signal TR to the firing circuit 123_4, at the time “t3”. The firing circuit 123_4 may output the spike signal SK2 in response to the signal TR (“firing”).

Between the time “t3” and a time “t4”, the level of the voltage, which is accumulated in the accumulation circuit 123_3, may be “V5”. At the time “t4”, the accumulation circuit 123_3 may accumulate the signal SI that is received from the inhibitory circuit 123_2. At the time “t4”, the level of the voltage, which is accumulated in the accumulation circuit 123_3, may decrease from “V5” to “V4”.

A difference (amount of increase in the level of the voltage that is accumulated at the time “t3”) between the “V5” and the “V2” may be greater than a difference (amount of increase in the level of the voltage that is accumulated at the time “t1”) between the “V3” and the “V1”. As an example, when the signal SE, which is received at the time “t1”, is generated based on the spike signal SK1 and the spike signal SK2 that are received with a time interval of “ΔT1”, and when the signal SE, which is received at the time “t3”, is generated based on the spike signal SK1 and the spike signal SK2 that are received with a time interval of “ΔT2”, the ΔT2 may be greater than the ΔT1.

A difference (amount of decrease in the level of the voltage that is accumulated at the time “t2”) between the “V3” and the “V2” may be less than a difference (amount of decrease in the level of the voltage that is accumulated at the time “t4”) between the “V5” and the “V4”. As an example, when the signal SI, which is received at the time “t2”, is generated based on the spike signal SK1 and the spike signal SK2 that are received with a time interval of “ΔT3”, and when the signal SI, which is received at the time “t4”, is generated based on the spike signal SK1 and the spike signal SK2 that are received with a time interval of “ΔT4”, the ΔT4 may be less than the ΔT3.

FIG. 10 is a graph for describing exemplary signals generated by a spike image generator of FIG. 1. In the example of FIG. 10, an x-axis represents a time and a y-axis represents a magnitude of the signal S2.

As described with reference to FIG. 6, the post-synaptic neurons, which are included in the spike image generator 120, may output the spike signal as the signal S2. By way of example, the post-synaptic neuron 123 of FIG. 6 may output the spike signal SK2 as the signal S2. As an example, the spike signals of the signal S2 as illustrated in FIG. 10 may be generated based on the spike signals of the signal S1 as illustrated in FIG. 4.

As described with reference to FIGS. 5 to 9, the spike image generator 120 may generate the spike signal under a certain condition through post-synaptic neuron. Therefore, the frequency value of the signal S2 may be less than the frequency value of the signal S1. As an example, the signal S2 in FIG. 4 may include “n” spike signals during the time interval “TD” and the signal S2 in FIG. 10 may include “n-k” spike signals during the time interval “TD”. That is, the “n-k” spike signals, which are selected from the “n” spike signals that are included in the signal S1, may be output as the signal S2 by the spike image generator 120.

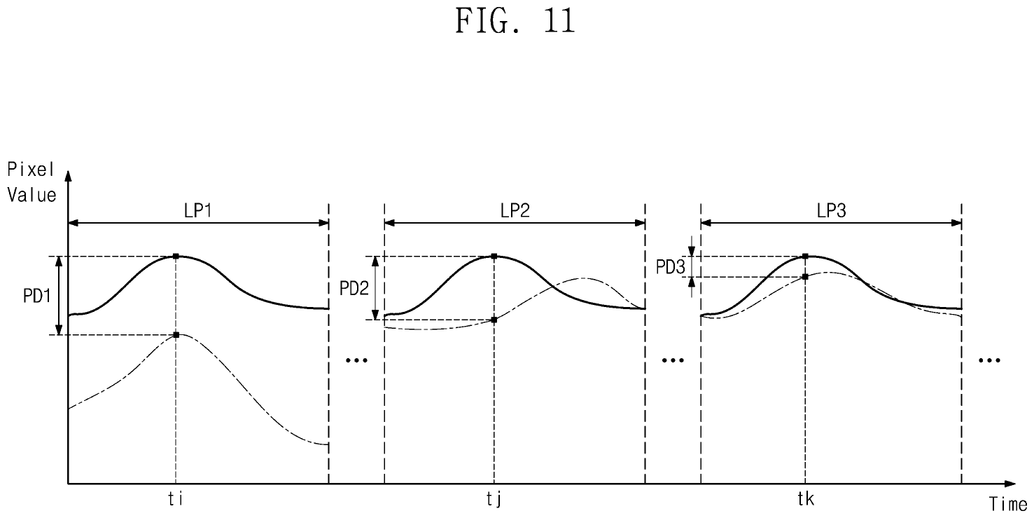

FIG. 11 is a graph for describing real data and fake data received by an image discriminator of FIG. 1. In the example of FIG. 11, an x-axis represents a time, and a y-axis represents pixel values. The solid line graphs represent the pixel values of the real data 20 and the dashed line graphs represent the pixel values of the fake data 30.

In the time intervals “LP1”, “LP2”, and “LP3”, the image discriminator 140 may receive the pixel values of the real data 20 and the pixel values of the fake data 30. The real data 20, which are received in the time intervals “LP1”, “LP2”, and “LP3”, may be the real data 20 described with reference to FIG. 2.

The spike image generator 120 may output the signal S2 through the neural network having a characteristic (e.g., weight) that varies based on the result data 40 being fed back. Since the result data 40 are generated based on the real data 20, the spike image generator 120 outputs the signal S2 through the neural network that is learned based on the result data 40, the pixel values of the fake data 30, which are output based on the signal S2, may be associated with the pixel values of the real data 20. As the difference between the pixel values of the real data 20 and the pixel values of the fake data 30 is continuously applied in the signal S2, the difference between the pixel values of the fake data 30 may decrease.

By way of example, at times “ti”, “tj”, and “tk”, the image discriminator 140 may receive the pixel values of the pixel PX2 of FIG. 2. At the time “ti”, the image discriminator 140 may obtain a difference value PD1 between the pixel value of the pixel PX2 that is indicated by the fake data 30 received in the time interval “LP1” and the pixel value of the pixel PX2 that is indicated by the real data 20. The image discriminator 140 may feed back the result data 40 having the PD1 to the spike image generator 120.

The spike image generator 120 may generate the signal S3 based on the weight W (i.e., learned by the result data 40) that is determined based on the result data 40. The image converter 130 may convert the signal S3 that is generated based on the result data 40 having the PD1 to output the fake data 30 in the time interval LP2.

At the time “tj”, the image discriminator 140 may obtain a difference value PD2 between the pixel value of the pixel PX2 that is indicated by the fake data 30 and the pixel value of the pixel PX2 that is indicated by the real data 20. The image discriminator 140 may feed back the result data 40 having the PD2 to the spike image generator 120.

The spike image generator 120 may generate the signal S3 based on the weight W (i.e., learned by the result data 40) that is determined based on the result data 40. The image converter 130 may convert the signal S3 that is generated based on the result data 40 having the PD2 to output the fake data 30 in the time interval LP3.

At the time “tk”, the image discriminator 140 may obtain a difference value PD3 between the pixel value of the pixel PX2 that is indicated by the fake data 30 and the pixel value of the pixel PX2 that is indicated by the real data 20. The image discriminator 140 may feed back the result data 40 having the PD3 to the spike image generator 120.

The PD2 may be less than the PD1, and the PD3 may be less than the PD2. As the result data 40 is continuously fed back, the differences between the pixel values of the fake data 30 and the data values of the real data 20 may decrease. That is, the electronic circuit 100 of FIG. 1 may repeatedly perform the STDP-based learning using the feedback result data 40 to generate the fake data 30 having characteristics similar to the real data 20.

According to embodiments of the inventive concept, an electronic circuit for implementing a generative adversarial neural network may operate with reduced time and power consumption.

The contents described above are specific embodiments for implementing the inventive concept. The inventive concept may include not only the embodiments described above but also embodiments in which a design is simply or easily capable of being changed. In addition, the inventive concept may also include technologies easily changed to be implemented using embodiments. Therefore, the scope of the inventive concept is not limited to the described embodiments but should be defined by the claims and their equivalents.

What is claimed is:

1. An electronic circuit for implementing a generative adversarial neural network, comprising:
a spike converter configured to generate a first signal including spike signals, the number of the spike signals being determined based on first data associated with second data within a reference time interval;
a spike image generator configured to generate a second signal including spike signals being selected, based on a weight, among the spike signals of the first signal;
an image converter configured to convert the spike signals of the second signal to generate third data being represented in an analog domain; and
an image discriminator configured to provide the spike image generator with result data being associated with a difference between a value of the third data and a value of the second data,
wherein the spike image generator is further configured to determine the weight based on the result data.

2. The electronic circuit of claim 1, wherein the spike image generator comprises:
a first synaptic neuron configured to generate a first neural spike signal based on the spike signals of the first signal;
a synapse circuit configured to generate a third signal having a level determined based on the first neural spike signal and a second neural spike signal; and
a second synaptic neuron configured to generate the second neural spike signal based on the third signal.

3. The electronic circuit of claim 2, wherein the synapse circuit has the weight determined based on the result data and is further configured to generate the third signal having a magnitude determined based on the weight.

4. The electronic circuit of claim 2, wherein the second synaptic neuron is further configured to accumulate the level of the third signal and to generate the second neural spike signal when the accumulated level of the third signal is greater than a threshold value.

5. The electronic circuit of claim 1, wherein the result data has a value obtained by subtracting the value of the third data from the value of the second data.

6. The electronic circuit of claim 1, wherein the first data, the second data, and the third data represent information associated with an image.

7. An electronic circuit for implementing a generative adversarial neural network, comprising:
a spike image generator configured to output first spike signals being selected, based on a weight, among second spike signals, the second spike signals being converted from first data associated with second data; and
an image discriminator configured to generate result data associated with a difference between a value of the second data and a value of third data being converted from the first spike signals,
wherein the spike image generator is further configured to have the weight determined based on the result data.

8. The electronic circuit of claim 7, wherein the spike image generator comprises:
a synaptic circuit configured to accumulate a level of a synapse signal generated based on the weight and to output the first spike signals when the accumulated level is greater than a threshold value.

9. The electronic circuit of claim 8, wherein the synaptic circuit comprises:
an excitatory circuit configured to generate a first signal when the level of the synapse signal is positive, wherein the first signal has a level corresponding to the level of the synapse signal; and
an inhibitory circuit configured to generate a second signal when the level of the synapse signal is negative, wherein the second signal has a level corresponding to the level of the synapse signal.

10. The electronic circuit of claim 9, wherein the synaptic circuit further comprises:
an accumulation circuit configured to accumulate the level of the first signal and the level of the second signal and to generate a neural spike signal when the accumulated levels are greater than the threshold value; and
a firing circuit configured to generate the first spike signals based on the neural spike signal.

11. The electronic circuit of claim 7, further comprising:
an image converter configured to convert the first spike signals into the third data being represented in an analog domain.
